(19) United States
(12) Patent Application Publication
(10) Pub. No.: US 2008/0218947 A1
(43) Pub. Date: Sep. 11, 2008

(54) Method and apparatus of integration for primary and secondary power with addition of fiber storage for use in FTTx deployments

(75) Inventor: Douglas A. Atkinson, Ashburn, VA (US)

Correspondence Address: FITZPATRICK CELLA (TELLABS), 30 ROCKEFELLER PLAZA, NEW YORK, NY, 10112-3800, US

(73) Assignee: TELLABS VIENNA, INC., Naperville, IL (US)

(21) Appl. No.: 11/715,754

(22) Filed: Mar. 8, 2007

(51) Int. Cl. H02B 1/26

(52) U.S. Cl. 361/622

(57) ABSTRACT

A mounting apparatus having at least one power source compartment, a slack storage unit attached thereto, and at least one mechanism configured to attachably receive at least one network terminal. A method of installing the apparatus comprises attaching a power source and the network terminal to the mounting apparatus and installing the mounting apparatus. In this manner, both time and costs of installing an ONT can be reduced.

### BACKGROUND OF THE INVENTION

1. Field of the Invention

The invention relates to optical network equipment installation, and, more specifically, to a method and apparatus for installing an optical network terminal (ONT) at customer premises during a fiber optic network deployment.

2. Description Of The Related Art

There is a growing demand in the industry to find a solution to transmit video from a headend to a customer premises through a fiber optic network all the way into an individual home or business. Such fiber optic networks generally are referred to as fiber-to-the-home (FTTH), fiber-to-the-premises (FTTP), fiber-to-the-business (FTTB), or fiber-to-the-curb (FTTC) networks and the like, depending on the specific application of interest. Such types of networks are also referred to herein generally as “FTTx networks.”

In a FTTP network, equipment at a headend or central office couples the FTTP network to external services such as a Public Switched Telephone Network (PSTN) or an external network. Signals received from these services are converted into optical signals and are combined onto a single optical fiber at a plurality of wavelengths, with each wavelength defining a channel within the FTTP network. The optical signals are transmitted through the FTTP network to an optical splitter that splits the optical signals and transmits the optical signals over a single optical fiber to a customer premises. At the customer premises, the optical signals are converted into electrical signals using an Optical Network Terminal (ONT). The ONT may split the resultant signals into separate services required by the customer such as computer networking, telephony and video.

A typical FTTx network such as, e.g., a FTTP network, often includes one or more Optical Line Terminals (OLTs) which each include one or more Passive Optical Network (PON) cards. Each OLT typically is communicatively coupled to one or more ONTs via an Optical Distribution Network (ODN) device. Such a typical network is illustrated in FIG. 5.

During a FTTx deployment, a service technician may visit the customer premises and install an ONT. An ONT has a connector for optically coupling with a fiber optic cable connected to the telecommunications service provider's ODN, and connectors for electrically coupling with customer premises equipment which can receive and provide communications in the FTTx network. Customer premises equipment may include standard telephones (e.g., Public Switched Telephone Network (PSTN)), Internet Protocol telephones, Ethernet units, video devices, computer terminals, digital subscriber line connections, cable modems, wireless access, as well as any other types of communications devices.

FIG. 4 shows a typical installation of an ONT 410 on an inside wall or structure 480 associated with a building or the like at a customer premises, as viewed from a perspective looking towards the inside wall or structure 480. One end 452 of a fiber optic cable 450 is connected to an ODN device (not shown), located on a power pole (not shown) disposed outside of the structure 480. A service technician brings the other end 451 of the fiber optic cable 450 towards the customer premises, drills a hole 460 through the wall or structure 480 from outside the structure 480, and feeds the fiber optic cable 450 through the hole 460 into the inside of the building so the cable 450 extends through the hole 460 as shown.

Inside the building, the service technician installs a fiber slack storage unit 401 by attaching it to the inside wall or structure 480 of the building. The service technician stores any slack of the fiber optic cable 450 inside the fiber slack storage unit 401, since it can be disadvantageous to unnecessarily shorten fiber optic cables by cutting them.

The service technician typically attaches an external enclosure 400, for housing the ONT 410, to a front face of the fiber slack storage unit 401. Finally, the ONT 410 is attached to the external enclosure 400. The service technician also installs a battery backup device 420 and a power supply 440 by attaching them to the inside wall or structure 480.

The battery backup device 420 typically contains a rechargeable battery and a battery backup unit for managing the rechargeable battery. Typically the power supply 440 is an AC to DC power supply with an AC power cord that plugs into a power outlet 470, and a DC power connector that supplies DC power via a wire 443 connected to battery backup device 420, or the like.

The service technician electrically connects the ONT 410 to the battery backup device 420 via wires 421, connects the battery backup device 420 to the power supply 440 via wires 443, connects fiber optic cable 450 to ONT 410, and connects the ONT 410 to customer premises equipment (not shown) via wires (not shown).

The ONT 410, battery backup device 420, and power supply 440 are typically installed separately to give the service technician flexibility in choosing installation locations for each device. For example, the service technician may need to install the ONT 410 or the battery backup device 420 at a location far from a power outlet 470. In some cases, service technicians may not use extension cords during installation. Also in some cases, national electrical code standards limiting the length of AC power cords and wires typically allow DC power wires to be longer than AC power cords. Therefore, when installing an ONT 410 or a battery backup device 420 at a location far from a power outlet 470, a service technician may need to install the power supply 440 near the power outlet 470 and bring the longer DC power wire 443 to the battery backup device 420 and the ONT 410.

In accordance with this method of installation, the fiber slack storage unit 401, battery backup device 420, and power supply 440 are separately attached to the wall or structure 480. Thus, the service technician must spend additional time attaching these three separate devices to the wall or structure.

Additionally, ONT 410 may not directly attach to fiber slack storage unit 401. Instead, ONT 410 may attach to an external enclosure 400, and the external enclosure 400 may attach to the fiber slack storage unit 401. The external enclosure 400 is used to protect the ONT 410 from outside elements, such as extreme temperatures, rain, snow, and the like. However, if the ONT 410 is installed inside a building, there may be no need for the external enclosure 400 other than to allow the ONT 410 to attach to the fiber slack storage unit 401. If the external enclosure 400 could be eliminated in such cases, installation time and costs could be reduced.

There is a need, therefore, for an improved method of installing an ONT, that reduces both installation time and costs, by reducing the number of components that are installed, and for an improved apparatus that achieves the same result.

### SUMMARY OF THE INVENTION

The foregoing and other limitations are overcome by a mounting apparatus according to example embodiments of the invention, and by a method for installing the apparatus.

The mounting apparatus has at least one power source compartment, a slack storage unit, and at least one mechanism to attach on at least one network terminal. A power source attaches to the mounting apparatus via the power source compartment, a network terminal attaches to the mounting apparatus via the mechanism, and the mounting apparatus is attached to a structure.

In another example aspect of the invention, the power source compartment includes at least one slot configured to receive at least one power source, and at least one power source is attached to the power source compartment.

In another example aspect of the invention, the power source compartment includes at least a primary power source compartment and a secondary power source compartment.

In another example aspect of the invention, at least one power source is disposed in the power source compartment. The power source includes a battery backup power supply unit, a battery unit, and an AC to DC power supply, and the power source compartment includes three power source compartments. The battery backup power unit attaches to the first compartment, the battery unit attaches to the second compartment, and the AC to DC power supply attaches to the third compartment.

In another example aspect of the invention, the network terminal is attached to the slack storage unit of the mounting apparatus.

In another example aspect of the invention, the mechanism includes at least one or more mounting holes.

In another example aspect of the invention, the network terminal includes an Optical Network Terminal (ONT).

In another example aspect of the invention, the mounting apparatus includes a door that is removably attached to at least the power source compartment.

In another example aspect of the invention, slack of at least one cable is stored in the slack storage unit.

In another example aspect of the invention, at least one passage is formed in at least one of the power source compartments and the slack storage unit, and is adapted to receive at least one cable.

In another example aspect of the invention, the power source is detached from the mounting apparatus and mounted separately.

In another example aspect of the invention, the power source is connected to a power outlet.

In another example aspect of the invention, the power source is connected to the network terminal.

As an example, a service technician can attach a single mounting apparatus to a wall instead of separately attaching a slack storage unit, battery backup unit, battery, and AC to DC power supply to a wall. Additionally, the battery backup unit, battery, and AC to DC power supply can be connected prior to installation. Because an ONT can be attached directly to a slack storage unit, an additional enclosure may not be required for installing an ONT. In this manner, both the time and costs of installing an ONT can be reduced.

This brief summary has been provided so that the nature of the invention may be understood quickly. A more complete understanding of the invention can be obtained by reference to the following detailed description, appended claims, and accompanying drawings.

### BRIEF DESCRIPTION OF THE DRAWINGS

The invention will be more readily understood from a detailed description of the invention taken in conjunction with the following figures:

FIG. 1 is a drawing depicting the installation of a mounting apparatus constructed according to an example embodiment of the present invention, at a customer premises.

FIG. 2 is a drawing depicting a mounting apparatus and a power supply installed separately in accordance with the example embodiment of the invention.

FIG. 3 is a drawing depicting the mounting apparatus after installation at a customer premises in accordance with an example embodiment of the invention.

FIG. 4 is a drawing depicting a conventional installation of an Optical Network Terminal (ONT).

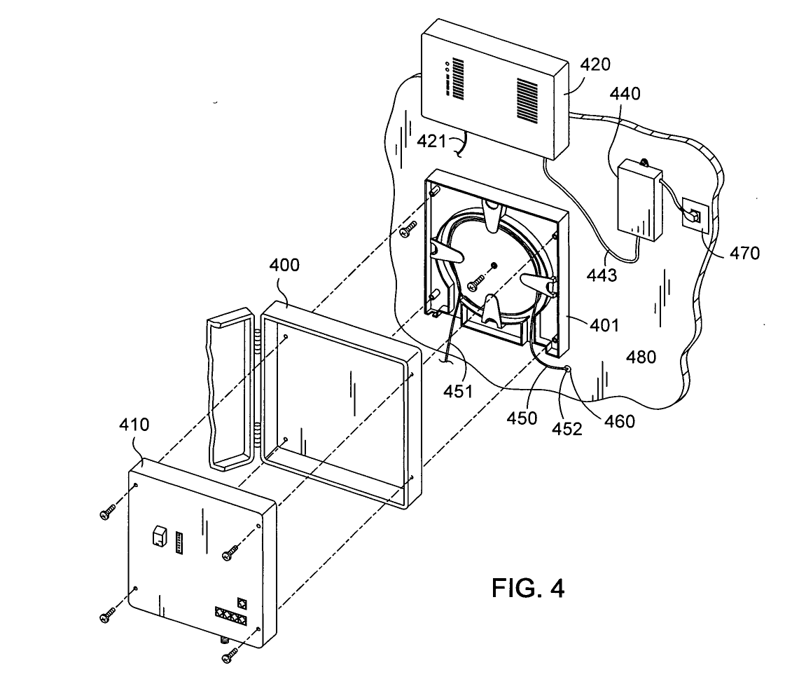

FIG. 5 is a network diagram depicting a typical fiber optic network.

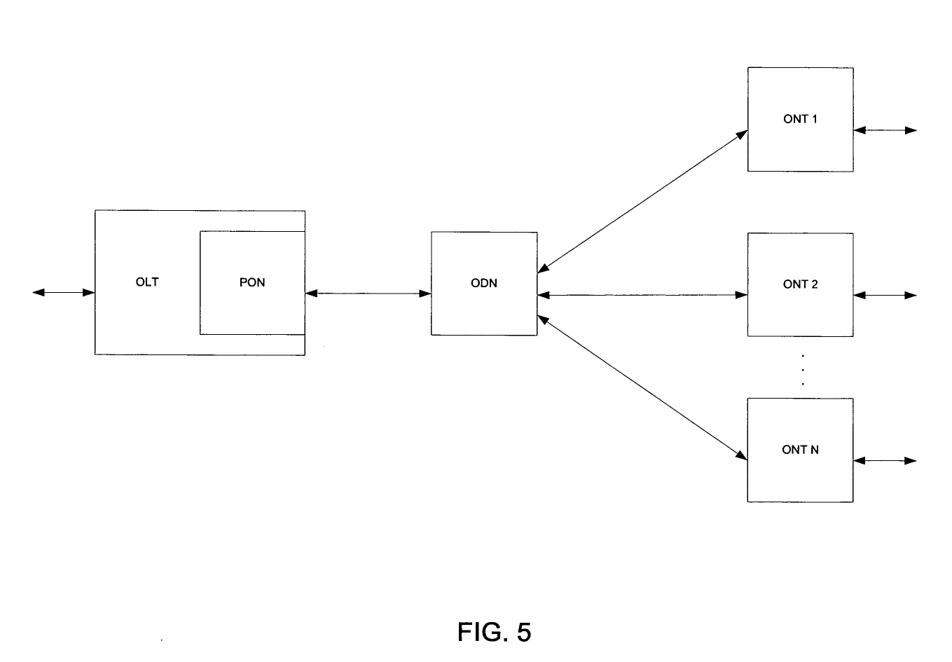

### DETAILED DESCRIPTION OF THE EXAMPLE EMBODIMENTS

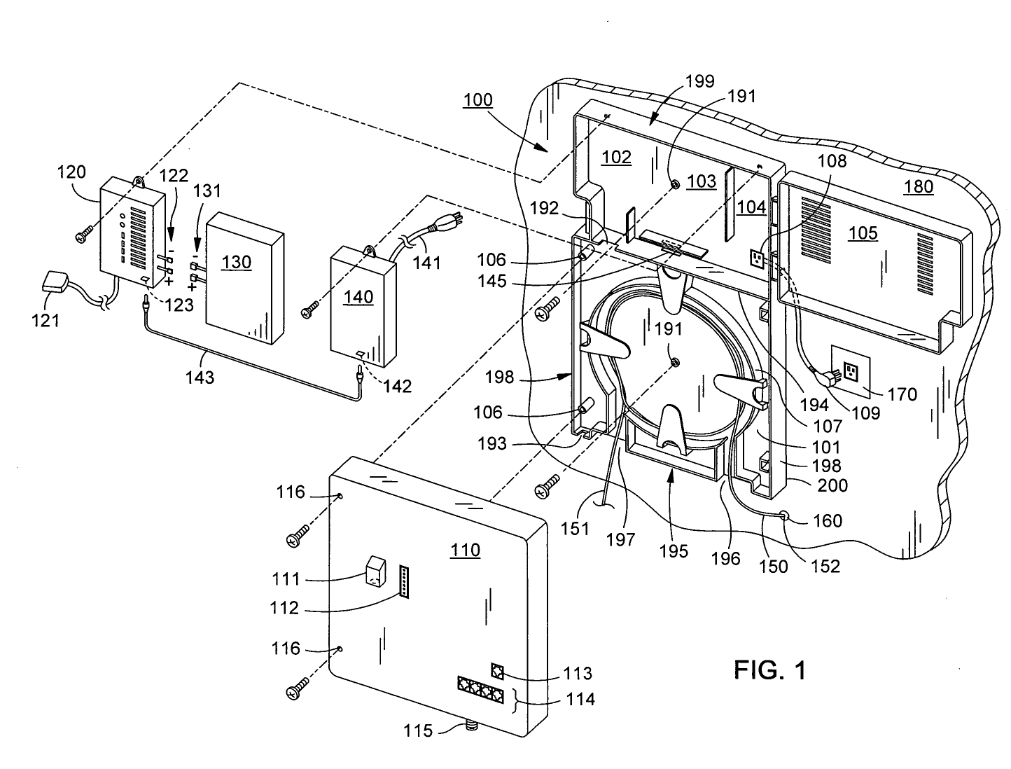

FIG. 1 is a perspective view of a mounting apparatus 100 mounted to wall or structure 180 at a customer premises, in accordance with an example embodiment of the invention, wherein the apparatus is represented in an exploded view. Mounting apparatus 100 is a mounting apparatus used to attach at least one or more of an Optical Network Terminal (ONT), battery backup unit, battery, and power supply to a wall or other predetermined structure at, for example, a customer premises, or any other switchable location, during a fiber optic network deployment.

According to a example embodiment of the invention, mounting apparatus 100 is an integrally formed enclosure having side walls 198, upper wall 199, lower wall 195, and rear wall 200, but it may also be formed of separate parts that are attachably combined by screws or the like. The apparatus 100 can be formed of any combination of plastic, metal, and any other suitable types of materials, or only a single material. An example plastic material may include Acrylonitrile Butadiene Styrene (ABS), or any other suitable type of plastic material. A metal material may include aluminum, steel, or any other suitable type of metal material. Also, in other embodiments the apparatus 100 can have other predetermined shapes besides that shown (e.g., rectangular).

Battery backup unit compartment 102, battery compartment 103, and power supply compartment 104 are locations within mounting apparatus 100 where battery backup unit 120, battery 130, and power supply 140 are insertable, respectively. Battery backup unit compartment 102, battery compartment 103, and power supply compartment 104 may be formed by spaces, slots, sockets, trays, partitions, cradles, shelves, mounting holes, clips, straps, or any other suitable type of area or mounting mechanism capable of receiving and/or housing the battery backup unit, battery, and power supply, respectively, within mounting apparatus 100. The power supply compartment 104 and battery compartment 103 are configured to enable power supply 140 and battery 130, respectively, to be removably attached thereto, and battery backup unit compartment 102 is configured to enable battery backup unit 120 to be removably attached thereto, but in other embodiments one or more of those compartments may be configured to enable attachment that is permanent. Battery backup unit compartment 102, battery compartment 103, and power supply compartment 104 can be electrically insulating, depending on applicable operating criteria.

Fiber slack storage unit 101 is a location within mounting apparatus 100 where slack of fiber optic cables, such as fiber optic cable 150, is stored. Fiber slack storage unit 101 is partitioned from an upper part of mounting apparatus 100 by bulkhead 194. Fiber slack storage unit 101 has spool 107 for spooling slack of fiber optic cable 150. Spool 107 and fiber slack storage unit 101 preferably are integrally formed, and spool 107 is fixed to the rear wall 200, but in other embodiments spool 107 and fiber slack storage unit 101 may be separate components that are coupled together using screws, bolts, fasteners, tabs, or the like, and spool 107 may or may not rotate. In either case, spool 107 is mounted to the wall 200 of fiber slack storage unit 101.

Bulkhead 194 and mounting apparatus 100 preferably are integrally formed, but in other embodiments they can be coupled together using screws, bolts, fasteners, tabs, or the like. Bulkhead 194 can be made of plastic, but it may also be made of metal, or any other suitable types of materials. Bulkhead 194 has aperture 192 through which cables and wires, such as ONT connector cable 121 and DC power wire 143, can be fed.

Channel 145 guides and/or secures one or more wires, such as wire 143, along a path, located in the internal area above bulkhead 194, between battery backup unit compartment 102 and power supply compartment 104. Channel 145 and mounting apparatus 100 preferably are integrally formed, but in other embodiments they may be coupled together using screws, bolts, fasteners, tabs, or the like. Channel 145 preferably is made of plastic, but it may also be made of metal, or any other suitable types of materials.

Lower wall 195 has apertures 196 and 197 through which a fiber optic cable, such as fiber optic cable 150, can be fed, as well as aperture 193, through which cables and wires, such as ONT connector cable 121 and DC power wire 143, can be fed.

Cover 105 preferably is an openable hinged door, but in other embodiments it can be an otherwise removably-fastenable cover, or any other suitable type of cover. When in a closed position, cover 105 covers battery backup unit compartment 102, battery compartment 103, and power supply compartment 104 (i.e., the internal area above bulkhead 194). ONT 110 attaches at a front of fiber slack storage unit 101, thereby covering fiber slack storage unit 101.

Mounting hardware 191 enables a service technician to install mounting apparatus 100 by fixedly attaching it to a wall or other structure 180. Mounting hardware 191 includes, for example, holes that accept bolts, screws, or the like, for attaching mounting apparatus 100 to wall or structure 180, although mounting hardware 191 can be any other suitable type of mounting hardware. ONT mounting hardware 106 are elongated channels or holes that accept bolts, screws, or the like, for attaching ONT 110 to mounting apparatus 100, although, mounting hardware 191 can be any other suitable type of mechanism for attaching ONT 110 to mounting apparatus 100.

AC power plug 108 is electrically coupled to AC power cord 109. AC power plug 108 receives a power supply's AC power cord, such as AC power cord 141, and thereby electrically couples cord 141 and power supply 140 to a wall power outlet, such as power outlet 170, via AC power cord 109.

Power supply 140 is preferably an AC to DC power supply functioning as the primary power source for ONT 110. Power supply 140 converts AC power received from power outlet 170 into DC power and provides DC power to a device, such as battery backup unit 120. For this purpose, power supply 140 has at least one DC power connector 142 for receiving DC power wires. The other end(s) of those wires is electrically connectable to a device, such as battery backup unit 120. Also, power supply 140 has AC power cord 141 for connecting directly to a wall power outlet, such as power outlet 170, or to an intermediate AC power plug of a device, such as AC power plug 108 (through which cord 141 can become electrically coupled to outlet 170, if cord 109 is connected thereto). Power supply 140 preferably has mounting hardware, such as mounting holes (not shown) at a back side and/or at one or more sides thereof, for removably attaching to power supply compartment 104 via, for example, screws, bolts, straps, clips, or any other suitable type of mounting mechanism.

Battery backup unit 120 and battery 130 preferably collectively form a battery backup device functioning as a secondary power source for ONT 110. Battery backup unit 120 has ONT connector cable 121 for electrically coupling with an ONT, such as ONT 110, at least one battery connector cable 122 for electrically coupling with a battery, such as battery 130, and power supply connector 123 for electrically coupling with a power supply, such as power supply 140 via cable 143. ONT connector cable 121 can be a cable having an insulation displacement connector, a set of bare leads, or the like, that electrically couples with a DC power connector, such as power connector 112 of ONT 110. Battery connector cable 122 has, for example, wires or other electrical conductors and corresponding connectors that electrically couple with positive and negative terminals of a battery, such as battery 130. Power supply connector 123 is a connector that receives an end of the DC power cable 143 which is connected at its other end to DC power connector 142 of a power supply, such as power supply 140. Battery terminals 131 are a positive and a negative battery terminal that electrically couple with one or more battery connector cables 122 of a battery backup unit, such as battery backup unit 120.

In an example embodiment, battery backup unit 120 removably attaches to mounting apparatus 100, but in other embodiments, battery backup unit 120 and mounting apparatus 100 can be integrally formed such that battery backup unit 120 is not removable from apparatus 100. Battery backup unit 120 preferably has mounting hardware, such as mounting holes (not shown) at a back side and/or at one or more sides thereof, for removably attaching to battery backup unit compartment 102 via, for example, screws, bolts, straps, clips, or any other suitable type of mounting mechanism. In an example embodiment, battery compartment 103 is a cradle, and battery 130 attaches to battery compartment 103 by being placed in the cradle and being retained by, for example, straps, clips, or any other suitable type of retaining mechanism (not shown), although the invention is not limited to this example only.

ONT 110 is any suitable type of ONT, such as those used as an interface between a service provider's fiber optic line leading up to a customer premises and one or more customer premises equipment or networks at the customer premises. ONT 110 has fiber optic connector 111 for optically coupling with a fiber optic cable, such as fiber optic cable 150, and connectors, such as data connector 113, voice connector 114, and video connector 115, for electrically coupling with customer premises equipment. ONT 110 also has power connector 112 for electrically coupling with wires providing DC power, such as wire 143 connected to DC power connector 142 or ONT connector cable 121.

Data connector 113 provides an Internet or other network connection to customer premises equipment. Data connector 113 can be, for example, a RJ-45 socket, one or more screws for attaching one or more bare leads, or any other suitable type of connector for receiving one or more wires connected at other ends to customer premises equipment, such as Internet Protocol telephones, Ethernet units, computer terminals, wireless access, as well as any other similar equipment.

Voice connector 1 14 includes one or more telephone connectors (receptacles) to which customer premises equipment can be electrically coupled, each telephone connector corresponding to, for example, a different telephone number. Voice connector 114 can include connectors such as RJ-11 connectors, RJ-12 connectors, RJ-25 connectors, one or more screws for attaching one or more bare leads, or any other suitable type of connectors, for receiving one or more wires connected to customer premises equipment, such as standard telephones (e.g., Public Switched Telephone Network (PSTN)), digital subscriber line connections, and the like.

Video connector 115 provides an analog or digital cable connection to customer premises equipment. Video connector 115 can be, for example, one or more coaxial cable connectors for receiving one or more coaxial cables connected at other ends to customer premises equipment, such as televisions, video recording devices, set-top boxes, one or more personal computers, and the like.

Fiber optic connector 111, power connector 112, data connector 113, and voice connector 114 are included at a front side of ONT 110, and video connector 115 is included at a lower side of ONT 110, although in other embodiments those connectors may be located at other parts of ONT 110 or in different orientations than that depicted. The front side of ONT 110 preferably faces away from mounting apparatus 100 when ONT 110 is attached to mounting apparatus 100. A back side of ONT 110 preferably faces mounting apparatus 100 when ONT 110 is attached to mounting apparatus 100.

Mounting hardware 116 includes holes that accept one or more bolts, screws, or the like, for attaching ONT 110 to mounting apparatus 100 by way of mounting hardware 106, although, mounting hardware 100 can be any other suitable type of mounting mechanism as well.

Prior to installation of the ONT 110, battery backup unit 120 and power supply 140 are attached to battery backup unit compartment 102 and power supply compartment 104, respectively, via screws, bolts, or any other suitable type of mounting mechanism as described above, and battery 130 is placed in battery compartment 103. One end of DC power wire 143 is connected to DC power connector 142, DC power wire 143 is passed through channel 145, and the other end of DC power wire 143 is connected to power supply connector 123. AC power cord 141 is connected to AC power plug 108, which is electrically coupled with AC power cord 109. Battery connector cable 122 is connected to battery terminals 131. DC power wire 143, AC power cord 141, and battery connector cable 122 preferably are enclosed within a volume of mounting apparatus 100 upon their installations therein.

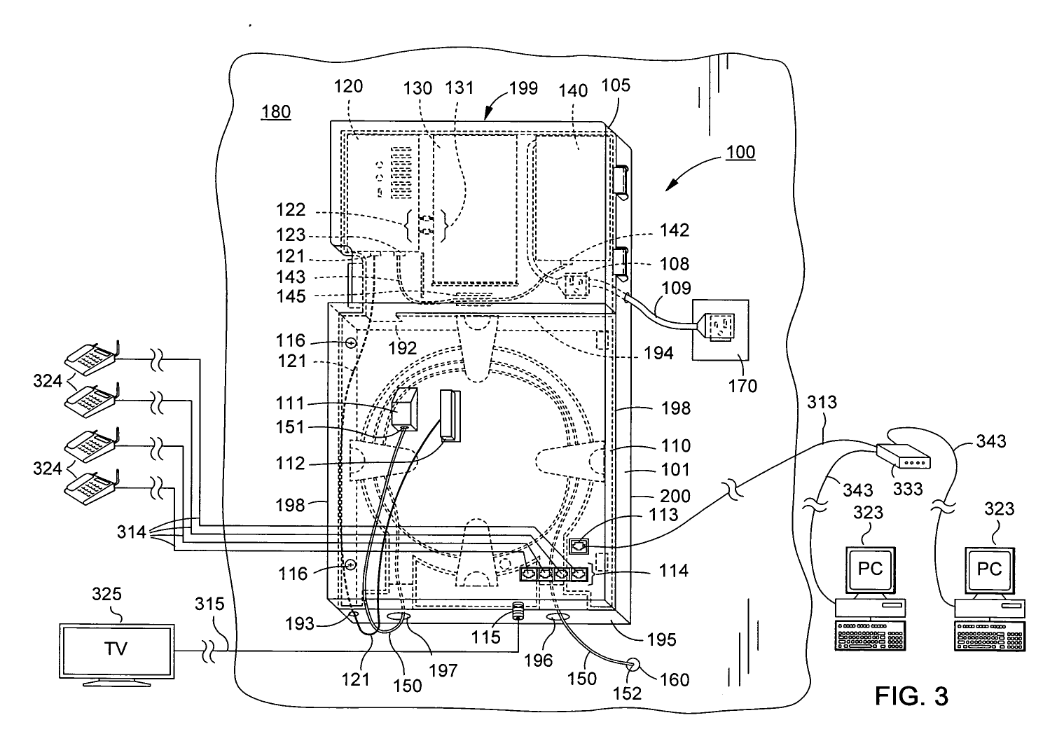

ONT connector cable 121 is fed through aperture 192, thereby exiting battery backup unit compartment 102, so that it can be connected to power connector 112 after ONT 110 is attached, as described below. Then, cover 105 preferably is closed, thereby covering battery backup unit compartment 102, battery compartment 103, and power supply compartment 104. FIG. 3 depicts apparatus 100 mounted on wall or structure 180, wherein cover 105 is shown in the closed position. For illustration purposes, battery backup unit 120, battery 130, and power supply 140, which are attached internally to mounting apparatus 100 and connected to each other in accordance with the foregoing description, are depicted with imaginary lines in FIG. 3 because they appear behind cover 105.

Referring to FIGS. 1 and 3, during installation, a service technician connects end 152 of fiber optic cable 150 to an optical distribution network device (not shown) located on a power pole, for example. Then the service technician drills hole 160 through wall or structure 180, and feeds customer end 151 of fiber optic cable 150 through hole 160 to the inside of the customer premises. The service technician installs mounting apparatus 100 by attaching it to wall or structure 180 inside the customer premises via mounting apparatus 100's mounting hardware 191 (FIG. 1) and screws, bolts, or the like. Fiber optic cable 150 is fed through aperture 196 of mounting apparatus 100 and slack is spooled around spool 107.

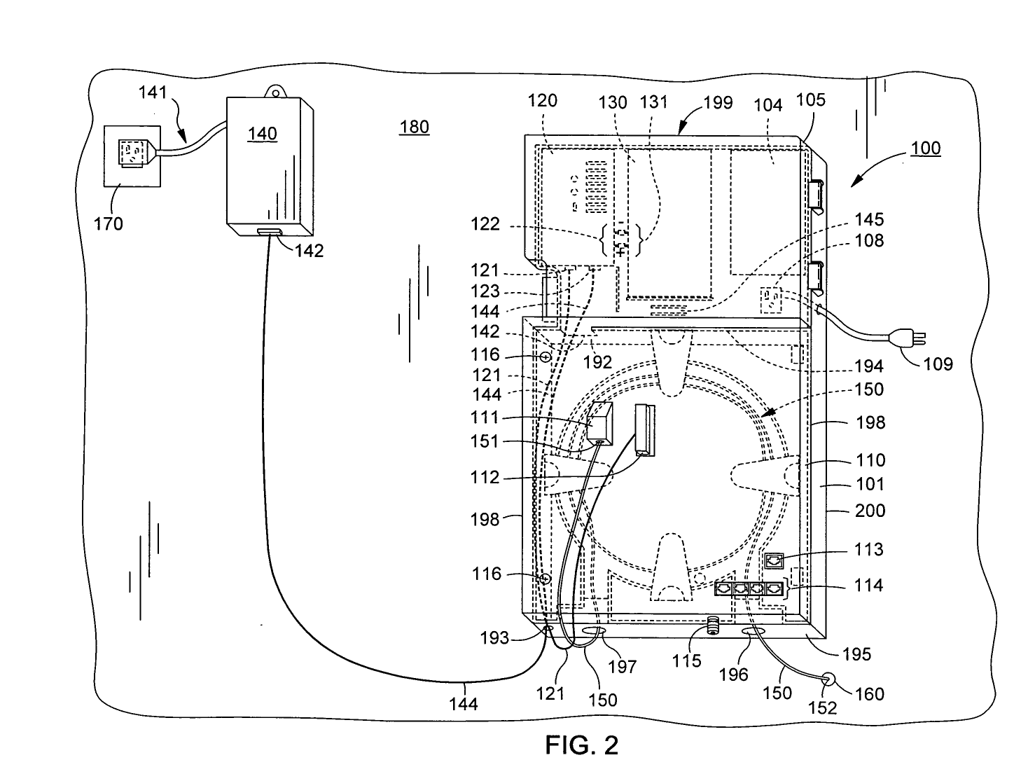

Because fiber optic connector 111 is provided at the front side of ONT 110, and ONT 110 covers fiber slack storage unit 101 once ONT 110 is attached, customer end 151 of fiber optic cable 150 is brought outside fiber slack storage unit 101 through aperture 197 so that it can be connected to fiber optic connector 111, as shown in FIG. 2 and FIG. 3.

In the illustrated embodiment, power connector 112 is located near lower wall 195 once ONT 110 is attached to mounting apparatus 100. Therefore, ONT connector cable 121 is passed through aperture 192 and fiber slack storage unit 101, and fed through aperture 193 of lower wall 195, so that it may exit mounting apparatus 100 near power connector 112, as shown in FIG. 2 and FIG. 3.

ONT 110 is placed over fiber slack storage unit 101 and attached thereto via mounting hardware 116, ONT mounting hardware 106, and screws, bolts, or the like. ONT 110 covers fiber slack storage unit 101 once ONT 110 is attached, as shown in FIG. 2 and FIG. 3. Customer end 151 of fiber optic cable 150 is then connected to fiber optic connector 111, and ONT connector cable 121 is connected to power connector 112.

Also, AC power cord 109 is connected to power outlet 170, and ONT 110 is connected to customer premises equipment as described below with further reference to FIG. 3.

If AC power cord 109 is not long enough to reach power outlet 170, power supply 140 can be removed from mounting apparatus 100 and installed near power outlet 170 as shown in FIG. 2.

FIG. 2 is a drawing depicting the mounting apparatus 100 and a power supply 140 installed separately in accordance with the example embodiment of the invention. AC power cord 141 is disconnected from AC power plug 108, and DC power wire 143 (not shown in FIG. 2) is disconnected from DC power connector 142 and power supply connector 123. When cover 105 is open, power supply 140 can be removed from apparatus 100 by removing its mounting mechanism. Power supply 140 then can be attached to wall or structure 180, near power outlet 170, via screws, bolts, or any other suitable type of mounting hardware. AC power cord 141 is connected to power outlet 170. A longer DC power wire 144 is connected to DC power connector 142 at one end. The other end of DC power wire 144 is brought to mounting apparatus 100, fed through aperture 193, passed through fiber slack storage unit 101, and fed through aperture 192 to enter battery backup unit compartment 102, where it is connected to battery backup unit 120 via power supply connector 123.

FIG. 3 is a drawing depicting the mounting apparatus 100 after installation at a customer premises in accordance with an example embodiment of the invention. Mounting apparatus 100, ONT 110, battery backup unit 120, battery 130, and power supply 140 are shown having been installed as described above in the detailed description of FIG. 1.

Data connector 113 provides an Internet or other network connection to customer premises equipment. Network cable 313 electrically couples with data connector 113. Network cable 313 can be a Cat 5 Ethernet cable, or any other suitable type of network cable. The end of network cable 313 that couples with data connector 113 may have a RJ-45 plug, bare wires, or the like. In the illustrated embodiment, the other end of network cable 313 is electrically coupled with customer premises equipment, such as a router 333, which is shown as being electrically coupled with information appliances such as, for example, personal computers 323. The end of network cable 313 that couples with router 333 has a plug, such as, for example, a RJ-45 plug, that plugs into a network cable connector, such as, for example, a RJ-45 socket, at router 333. Alternatively, network cable 313 can be connected to a wall jack (not shown) having a socket for receiving another network cable, and the other network cable can be plugged into the wall jack at one end, and plugged into the network cable connector at router 333 at the other end.

Router 333 can be, for example, an Ethernet router or any other suitable type of router that enables one or more information appliances, such as personal computers 323, to access a network, such as the Internet, via ONT 110 and data connector 113. Network cables 343 connect personal computers 323 to router 333. Network cables 343 can be Cat 5 Ethernet cables, or any other suitable type of network cables. Network cables 343 each have plugs on both ends, such as RJ-45 plugs, that plug into network cable connectors, such as RJ-45 sockets, on router 333 and personal computers 323. Personal computers 323 may be desktop computers, laptop computers, or any other device capable of accessing a network.

Voice connector 114 includes one or more telephone connectors for customer premises equipment, each telephone connector corresponding to, for example, a different telephone number. Telephone cables 314 electrically couple with voice connector 114, each of telephone cables 314 electrically coupled with a different telephone connector. Telephone cables 314 can be Cat 3 twisted pair cables, or any other suitable type of telephone cable. The ends of telephone cables 314 that couple with voice connector 114 may have RJ-11 plugs, RJ-12 plugs, RJ-25 plugs, bare wires, or the like. The other ends of telephones cables 314 are electrically coupled with customer premises equipment, such as telephones 324. The end of telephones cables 314 that couple with telephones 324 have plugs, such as RJ-11 plugs, RJ-12 plugs, or RJ-25 plugs, that plug into telephone cable connectors, such as an RJ-11 sockets, RJ-12 sockets, or RJ-25 sockets, or the like, on telephones 324. Alternatively, telephone cables 314 can be connected to wall jacks (not shown) having sockets for receiving other telephone cables, and the other telephone cables can be plugged into the wall jacks at one end, and plugged into the telephone cable connectors on telephones 324 at the other end.

Video connector 115 is a cable connector for customer premises equipment. Television cable 315 electrically couples with video connector 115. Television cable 315 can be a RG-6 coaxial cable, or any other suitable type of television cable. The end of television cable 315 that couples with video connector 1 15 may have a RG-6 connector, or the like. The other end of television cable 315 is electrically coupled with television 325, but it may also be electrically coupled with a video recording device, set-top box, or any other device capable of receiving a cable connection. The end of television cable 315 that couples with television 325 has a plug, such as a RG-6 connector, that plugs into a television cable connector, such as a RG-6 socket, on television 325. Alternatively, television cable 315 can be connected to a wall jack (not shown) having a socket for receiving another television cable, and the other television cable can be plugged into the wall jack at one end, and plugged into the television cable connector on television 325 at the other end.

As can be appreciated in view of the foregoing description, the example embodiment(s) of the invention can reduce both installation time and installation costs. For example, a service technician can attach the single mounting apparatus 100 to wall or structure 180, instead of separately attaching a separate fiber slack storage unit, battery backup unit, battery, and power supply. Additionally, battery backup unit 120, battery 130, and power supply 140 can be connected to each other prior to installation as part of a prepackaged product, and thus installation time can be reduced because a service technician does not have to connect these devices while at the customer premises. Moreover, because ONT 110 can be attached directly to fiber slack storage unit 101, an additional enclosure dedicated exclusively for the ONT is not required. In this manner, the example embodiment(s) of the invention reduce both installation time and installation costs.

It should be noted that the various types of connections, sockets, receptacles, cables, wires, and the like, described above are merely illustrative in nature and are not intended to limit the scope of this invention. Indeed, it is within the scope of this invention to use any suitable types of such devices and not only those described herein. Moreover, although the invention has been described in the context of being used in conjunction with an ONT, battery power sources, and cable wires in a fiber-to-the-premises (FTTP) environment, it also is within the scope of this invention to employ the mounting apparatus 100 in other environments such as fiber-to-the-home (FTTH), fiber-to-the-business (FTTB), or fiber-to-the-curb (FTTC) environments, and to install other types of equipment in lieu of, or in addition to, ONT's, battery power sources, and cable wires. For example, other embodiments of the invention can be used to install CATV (Community Access Television) devices, such as cable moderns, and any other types of devices capable of supporting any combination of voice, data, and video services, and, if deemed necessary, can be configured to mount and/or house such equipment. Moreover, in other embodiments the mounting apparatus 100 can be constructed to house or mount more or less than the number of devices 110, 120, 130, 140, and 150 shown and described herein, depending on applicable design criteria.

While the invention has been particularly shown and described with respect to an example embodiment thereof, it should be understood that the embodiment has been presented by way of example, and not limitation. It will be apparent to persons skilled in the relevant art(s) that various changes in form and detail can be made therein without departing from the spirit and scope of the present invention. Thus, the present invention should not be limited by the above-described example embodiment, but should be defined only in accordance with the following claims and their equivalents.

In addition, it should be understood that the figures illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Furthermore, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way. It is also to be understood that the steps and processes recited in the claims need not be performed in the order presented.

What is claimed is:

1. A mounting apparatus for network equipment, comprising:
at least one power source compartment;
a slack storage unit attached to the power source compartment; and
at least one mechanism configured to attachably receive at least one network terminal.

2. The apparatus according to claim 1, wherein the at least one power source compartment includes at least one slot configured to receive at least one power source.

3. The apparatus according to claim 1, wherein the at least one power source compartment includes at least a primary power source compartment and a secondary power source compartment.

4. The apparatus according to claim 1, further comprising at least one power source disposed in the at least one power source compartment.

5. The apparatus according to claim 4, wherein the at least one power source includes a battery backup power supply unit, a battery unit, and an AC to DC power supply.

6. The apparatus according to claim 5, wherein the at least one power source compartment includes three power source compartments adapted to receive the battery backup power supply unit, the battery unit, and the AC to DC power supply.

7. The apparatus according to claim 1, wherein the at least one mechanism is configured to fixedly attach the at least one network terminal to the slack storage unit.

8. The apparatus according to claim 1, wherein the at least one mechanism includes at least one or more mounting holes.

9. The apparatus according to claim 1, wherein the at least one network terminal includes an Optical Network Terminal (ONT).

10. The apparatus according to claim 1, further comprising a door that is removably attached to at least the at least one power source compartment.

11. The apparatus according to claim 1, wherein the slack storage unit is configured to store slack of at least one cable.

12. The apparatus according to claim 1, wherein at least one passage is formed in at least one of the power source compartments and the slack storage unit, and is adapted to receive at least one cable therein.

13. A method of installing network equipment, comprising:
attaching at least one power source and at least one network terminal to a same mounting apparatus configured to receive them; and
attaching the mounting apparatus to a structure.

14. The method according to claim 13, wherein the attaching of the at least one power source includes attaching the at least one power source to at least one power source compartment of the mounting apparatus.

15. The method according to claim 13, wherein the attaching of the at least one network terminal includes attaching the at least one network terminal to a slack storage unit of the mounting apparatus.

16. The method according to claim 13, wherein the at least one power source includes a battery backup power unit, a battery unit, and an AC to DC power supply.

17. The method according to claim 13, further comprising detaching the at least one power source from the mounting apparatus and mounting it separately therefrom.

18. The method according to claim 16, wherein the mounting apparatus includes first, second, and third compartments, and wherein the attaching of the at least one power source includes attaching the battery backup power unit to the first compartment, attaching the battery unit to the second compartment, and attaching the AC to DC power supply to the third compartment.

19. The method according to claim 13, wherein the at least one network terminal includes an Optical Network Terminal (ONT).

20. The method according to claim 13, further comprising storing slack of at least one cable in a slack storage unit of the mounting apparatus.

21. The method according to claim 13, further comprising connecting the at least one power source to a power outlet.

22. The method according to claim 13, further comprising connecting the at least one power source to the at least one network terminal.
